(19) United States
(12) Patent Application Publication
(10) Pub. No.: US 2023/0037358 A1
(43) Pub. Date: Feb. 9, 2023

(54) TEMPORARY MASKING FILM DRAPE WITH REVERSE ADHESIVE

(71) Applicants: Ronald Lipson, Orchard Lake, MI (US); Nick Rieser, Warren, MI (US)

(72) Inventors: Ronald Lipson, Orchard Lake, MI (US); Nick Rieser, Warren, MI (US)

(21) Appl. No.: 17/882,776

(22) Filed: Aug. 8, 2022

Related U.S. Application Data
(60) Provisional application No. 63/231,197, filed on Aug. 9, 2021.

(51) Int. Cl. C09J 7/00; C09J 5/00

(52) U.S. Cl. CPC C09J 7/00; C09J 5/00; C09J 2203/37; C09J 2203/306; C09J 2203/31

(57) ABSTRACT

A temporary surface masking film is provided with an adhesive tape that faces outwardly, thereby dramatically improving the process of application. At least the film may be transparent or translucent and the film may be accordion-folded onto the roll. The width of the film may be in the range of 1 to 12 feet. The roll may be retained in a plastic carrier, with a serrated edge for cutting the film. The roll may be coupled to an axial handle, and the roll and handle are provided in a plastic carrier. A method includes adhering a portion of the outwardly facing adhesive tape to a surface to be protected. The film is then unrolled such that it unfolds, hangs down and clings to the surface. The film may then be cut when the surface to be protected is sufficiently covered. Conveniently, the inventive film may be applied by a single user.

### REFERENCE TO RELATED APPLICATIONS

This application claims priority to, and the benefit of, U.S. Provisional Patent Application Ser. No. 63/231,197, filed Aug. 9, 2021, the entire content of which is incorporated herein by reference.

### FIELD OF THE INVENTION

This invention relates generally to materials for temporarily masking surfaces on vehicles and other objects and, in particular, to a masking film wherein the adhesive surface is facing outwardly easier application.

### BACKGROUND OF THE INVENTION

There are many instances wherein portions of a vehicle or other surfaces need to be temporarily masked, for sanding and painting, for example. There are masking “drape” products comprising a plastic film with an adhesive edge to drape down onto the surface. A problem with existing films, however, is that the adhesive is inwardly directed—that is, toward the center of the roll. This makes is difficult to apply the film.

When the film comes off the top of the roll, placement is problematic, making it difficult to align and smooth the product during placement. Creases develop due to the film sticking to itself, resulting in overlapping regions and an unsatisfactory result.

### SUMMARY OF THE INVENTION

This invention addresses and solves problems associated with the prior art by providing a temporary surface masking film having an adhesive tape that faces outwardly, thereby dramatically improving the process of application. In preferred embodiments, one edge of the tape and one edge of the film are co-extensive.

A product for masking a vehicle or other surface according to the invention comprises a roll of thin, flexible plastic film disposed on a roll, and wherein at least one edge of the film includes an adhesive tape that faces outwardly and away from the center of the roll. At least the film may be transparent or translucent and the film may be accordion-folded onto the roll. The width of the film may be in the range of 1 to 12 feet.

The roll may be retained in a plastic carrier, enabling the film to be unrolled and applied by holding the carrier. The plastic carrier may include a serrated strip for cutting the film. The roll may be coupled to an axial handle, and the roll and handle are provided in a plastic carrier.

A method of masking a surface in accordance with the invention comprises the steps of providing a product configured according to the invention, and adhering a portion of the outwardly facing adhesive tape to a surface to be protected. The film is then unrolled such that it unfolds, hangs down and clings to the surface. The film may then be cut when the surface to be protected is sufficiently covered.

Conveniently, the inventive film may be applied by a single user.

### BRIEF DESCRIPTION OF THE DRAWINGS

FIG. 1 is photo that shows different-width products according to the invention; and

FIG. 2 is a photo that shows an individual applying one of the films of FIG. 1;

FIG. 3 is a photo that shows how a portion of a dispenser may be used to tear the masking film;

FIG. 4 is a photo that shows the side of a vehicle covered with a wider masking film product; and

FIG. 5 is a drawing that shows how one of the masking film products is made.

### DETAILED DESCRIPTION OF THE INVENTION

This invention addresses and solves such problems associated with the prior art by providing a temporary surface masking film wherein an adhesive tape faces outwardly, thereby dramatically improving the process of application.

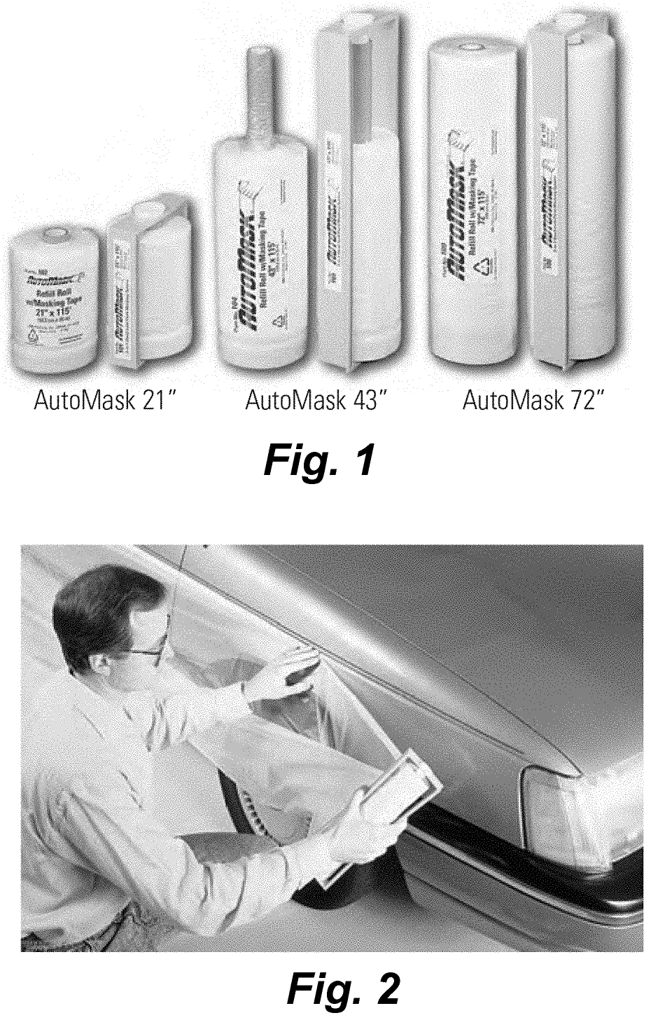

FIG. 1 is photo that shows different-width products according to the invention, including widths of 21″, 43″ and 72″. Certainly other widths are possible. Note that the height of the products shown in FIG. 1 are less than the film itself, since the film is accordion-folded onto the roll.

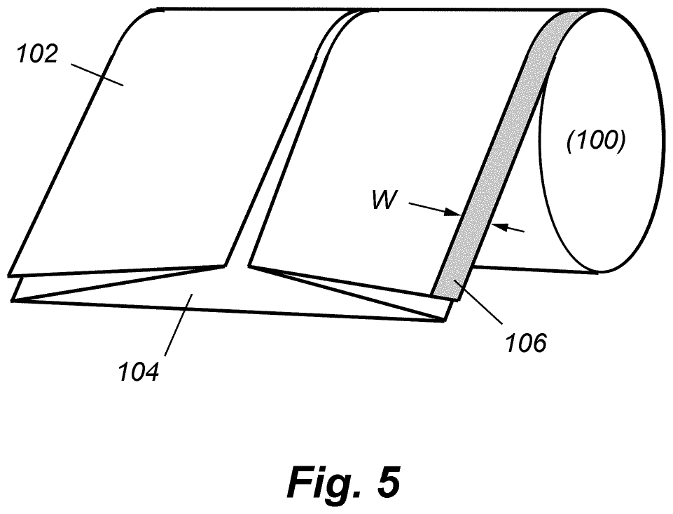

Each embodiment includes a roll of thin plastic film with an outwardly facing adhesive tape positioned along one edge of the roll. For smaller widths (i.e., 21″ and 43″), the adhesive tape have a width (“W” on FIG. 5) of ¾″ more or less, whereas with larger widths, the tape is wider as well (i.e., up to 1½″ or greater). The adhesive of the tape is preferably a medium-tack adhesive that enables the film to stick to the surface and hand down in drape fashion while also enabling the film to be removed from the surface after use without damage. In preferred embodiments, one edge of the tape and one edge of the film are co-extensive.

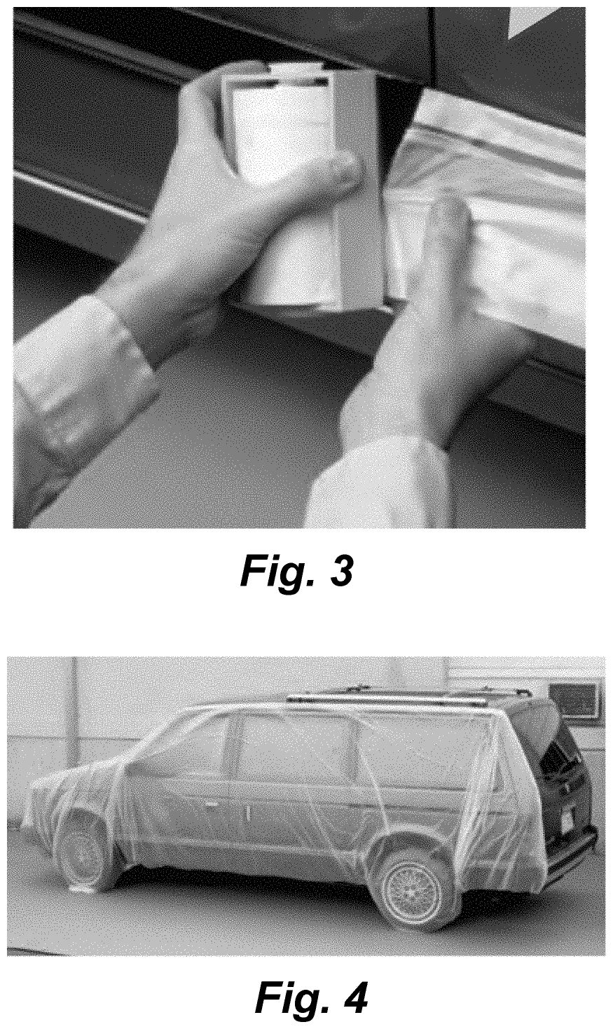

FIG. 2 is a photo that shows an individual applying a 43″ wide film to the side of a vehicle. In the preferred embodiments, the roll of film is contained in a dispenser comprising a pair of opposing, elongated strips of hard plastic material, enabling the user to grasp the roll by these strips for unrolling without interference. As shown in FIG. 3, one or both of these elongated strips may include a serrated edge to tear the film after application. The packaging may further include a roll with a handle that may be detached from the plastic carrier and applied by grasping the handle instead of the carrier.

FIG. 4 is a photo that shows the side of a vehicle covered with a wider masking film product. As mentioned, the product hangs down in curtain-like fashion, while also providing a strong static-free “cling” to the surface.

FIG. 5 is a drawing that shows how one of the masking film products is made. The film 102 is accordion-folded (i.e., 104) on the roll 100. In contrast to all other products, the adhesive of tape 106 faces outwardly, facilitating a more accurate and satisfying application. Note that while one accordion fold is shown, multiple folds may be used, particularly with wider products.

In applying the film, the user simply attached a small section of the adhesive tape to the surface, then mores the dispenser (or handle) along the surface as the film progressively unfolds and clings to the surface to be protected. Other advantages of the invention include the following:

Lint free—eliminates risk of masking paper fiber contamination.

Anti-static.

Ultimate solvent bleed-thru resistance. Even paint stripper can't penetrate it.

Resists heat up to 230° F. (110° C.).

Completely waterproof—wet sand—wet sand—wet sand.

Recyclable.

Uses high quality, automotive-grade adhesive masking tape.

Superior flexibility.

Resists splitting.

Easy to remove.

No adhesive transfer.

Compactibility—wads up into small, space-saving, throw-away balls. Conserves disposal space up to 70%.

1. A product for masking a vehicle or other surface, comprising:
a roll of thin, flexible plastic film disposed on a roll;
wherein at least one edge of the film includes an outwardly facing adhesive tape, and wherein the adhesive of the tape faces outwardly and away from the center of the roll.

2. The product of claim 1, wherein the at least the film is transparent or translucent.

3. The product of claim 1, wherein the film is accordion-folded onto the roll.

4. The product of claim 1, wherein the width of the film is in the range of 1 to 12 feet.

5. The product of claim 1, wherein the roll in retained in a plastic carrier enabling the film to be unrolled and applied by holding the carrier.

6. The product of claim 1, wherein the roll in retained in a plastic carrier including a serrated strip for cutting the film.

7. The product of claim 1, wherein the roll is coupled to an axial handle.

8. The product of claim 1, wherein the roll and handle are provided in a plastic carrier

9. A method of masking a surface, comprising the steps of:
providing the product of claim 1;
adhering a portion of the outwardly facing adhesive tape to a surface to be protected;
unrolling the film such that it unfolds, hangs down and clings to the surface; and
cutting the film when the surface to be protected is sufficiently covered.

10. The method of claim 9, wherein the film is applied by a single user.
